(19) United States
(12) Patent Application Publication
(10) Pub. No.: US 2026/0011936 A1
(43) Pub. Date: Jan. 8, 2026

(54) CONNECTION TERMINAL FOR CONNECTING AN ELECTRICAL WIRE

(71) Applicant: PHOENIX CONTACT GMBH & CO. KG, Blomberg (DE)

(72) Inventor: Dennis GEISLER, Extertal (DE)

(21) Appl. No.: 18/992,581

(22) PCT Filed: Jul. 12, 2023
(86) PCT No.: PCT/EP2023/069280

§ 371 Date: Jan. 9, 2025

(30) Foreign Application Priority Data
Jul. 21, 2022 (LU) 502537

(51) Int. Cl. H01R 4/48

(52) U.S. Cl. CPC H01R 4/4835; H01R 4/4821; H01R 4/483

(57) ABSTRACT

A connection terminal for connecting an electrical wire includes: a housing having an insertion opening into which the electrical wire is insertable for connection to the connection terminal; a contact element arranged on the housing, the contact element electrically contacting the electrical wire; a spring element arranged on the housing, the spring element having a clamping portion for interacting with the electrical wire to bring the electrical wire into contact with the contact element; an actuation element pivotally arranged on the housing, the actuation element being movable from a non-actuated position into an actuated position so as to move the clamping portion; and a release element having a supporting end arranged to be stationary relative to the housing and a release portion elastically movable relative to the supporting end. The actuation element engages the release element when in the actuated position to hold the actuation element in the actuated position.

### CROSS-REFERENCE TO PRIOR APPLICATIONS

This application is a U.S. National Phase application under 35 U.S.C. § 371 of International Application No. PCT/EP2023/069280, filed on Jul. 12, 2023, and claims benefit to Luxembourg Patent Application No. LU 502537, filed on Jul. 21, 2022. The International Application was published in German on Jan. 25, 2024 as WO/2024/017725 under PCT Article 21(2).

### FIELD

The invention relates to a connection terminal for connecting an electrical wire.

### BACKGROUND

Such a connection terminal comprises a housing which has a insertion opening into which the electrical wire can be inserted for connection to the connection terminal. A contact element for electrically contacting the electrical wire is arranged on the housing. On the housing, a spring element is also arranged, which has a clamping portion which is designed to act upon the electrical wire in order to bring the electrical wire into contact with the contact element when the electrical wire is inserted into the insertion opening. An actuation element can be actuated by a user in order to move the clamping portion. For this purpose, the actuation element can be moved from a non-actuated position to an actuated position, e.g., using a tool, so that, in the actuated position, the clamping portion is moved—for example, to facilitate insertion of the electrical wire into the insertion opening or to remove the electrical wire from the insertion opening.

By using the spring element, such a connection terminal establishes a spring force connection in which, in the connected position, the electrical wire is clamped to the contact element under the elastic action of the spring element and is thus electrically connected to the contact element.

In a connection terminal known from DE 10 2019 127 464 B3, a spring element in the form of a tension spring is provided, which pulls a connected electrical wire into abutment with an associated contact element by the resilient action of the spring and thus establishes a clamping connection between the electrical wire and the contact element. For this purpose, when attaching the electrical wire, it is pushed through an opening in the clamping portion and is clamped between the clamping portion and the contact element when in the connected position.

The connection terminal in DE 10 2019 127 464 B3 provides a locking device used to lock the clamping portion relative to the housing in a release position. When the electrical wire is inserted, the locking device is released and the locking engagement is therefore released such that clamping portion is moved from the release position and the electrical wire is thereby clamped to the contact element. In order to move the clamping portion into the release position, in particular to allow the electrical wire to be attached or to release a connected electrical wire from the connection terminal, a tool, e.g., a screwdriver, can be attached to the connection terminal, and a force can thereby be exerted on the clamping portion.

While, in DE 10 2019 127 464 B3, the clamping portion is directly moved by means of a tool, in each of the connection terminals known from DE 10 2019 135 203 A1 and DE 10 2020 104 140 A1, an actuation element in the form of a so-called pusher is provided which can be pushed into the housing of the connection terminal in order to thereby act upon the clamping portion and to transfer the clamping portion into its release position. The actuation element is spring-loaded relative to the housing of the connection terminal via a clamping spring in the form of a compression spring. In the connection terminal known from DE 10 2019 135 203 A1, an actuating lug is arranged on the actuation element, which hooks into a fastening portion of a retaining element when the actuation element is in the actuated position.

### SUMMARY

In an embodiment, the present invention provides a connection terminal for connecting an electrical wire, comprising: a housing having an insertion opening into which the electrical wire is insertable for connection to the connection terminal; a contact element arranged on the housing, the contact element being configured to electrically contact the electrical wire; a spring element arranged on the housing, the spring element having a clamping portion configured to interact with the electrical wire to bring the electrical wire into contact with the contact element; an actuation element pivotally arranged on the housing, the actuation element being movable from a non-actuated position into an actuated position so as to move the clamping portion; and a release element having a supporting end arranged to be stationary relative to the housing and a release portion elastically movable relative to the supporting end, wherein the actuation element is configured to engage the release element when in the actuated position so as to hold the actuation element in the actuated position, wherein the release portion is configured to interact with the electrical wire when the electrical wire is inserted into the insertion opening so as to release the actuation element from the actuated position.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1A is a view of an exemplary embodiment of a connection terminal in a non-actuated position of an actuation element;

FIG. 1B is a side view of the arrangement according to FIG. 1A;

FIG. 2A is a view of the connection terminal in an actuated position of the actuation element;

FIG. 2B is a side view of the arrangement according to FIG. 2A;

FIG. 3A is a view of the connection terminal when an electrical wire interacts with a release element;

FIG. 3B is a side view of the arrangement according to FIG. 3A;

FIG. 4A is a view of the connection terminal after inserting the electrical wire and releasing the actuation element from the actuated position;

FIG. 4B is a side view of the arrangement according to FIG. 4A;

FIG. 5A-5D are views of an exemplary embodiment of an actuation element; and

FIG. 6A, 6B are views of a further exemplary embodiment of an actuation element.

### DETAILED DESCRIPTION

In an embodiment, the present invention provides a connection terminal which makes it possible in a simple manner to hold the clamping portion of the spring element in a release position and to transfer it into a clamping position when an electrical wire is inserted.

Accordingly, the connection terminal has a release element which has a supporting end arranged to be stationary relative to the housing and a release portion which is elastically movable relative to the supporting end. The actuation element is designed to engage with the release element in the actuated position so that the actuation element is held in the actuated position. The release portion is designed to interact with the electrical wire when said wire is inserted into the insertion opening to release the actuation element from the actuated position.

The electrical wire in the connection terminal is electrically contacted by the electrical contact element by the clamping portion acting upon the electrical wire when said electrical wire is inserted into the insertion opening and applying an elastic load thereto in the direction of contact with the contact element. To make it easier to attach the electrical wire, the clamping portion of the spring element can be elastically deflected by actuating the actuation element in order to thereby move the clamping portion into a release position in which a space in the region of the insertion opening is cleared, and the electrical wire can accordingly be inserted into the insertion opening substantially without any force, or a connected electrical wire can (alternatively) be easily removed from the connection terminal. The actuation element can, for example, be designed as a pusher and can be pushed into the housing by user actuation while pivoting relative to the housing in order to thereby act upon the clamping portion and to move the clamping portion in the direction of the release position.

In the actuated position, the actuation element, which is pivotally mounted on the housing, engages with a release element which is supported on the housing via a supporting end on the housing or on a part connected to the housing. In the actuated position, the actuation element is accordingly held in position by the release element such that the clamping portion of the spring element is thereabove also held in its release position in which it is possible to easily attach an electrical wire to the connection terminal or to remove a connected wire from the connection terminal substantially without any force.

The release element is used to engage with the actuation element in the actuated position. By actuating the actuation element, the clamping portion can accordingly be moved relative to the housing and transferred into a release position such that in particular it is possible to easily insert an electrical wire into the insertion opening in the housing in order to connect the wire to the connection terminal. In so doing, the release element also serves to release the actuation element from the actuated position in order to automatically release the actuation element from the actuated position when the electrical wire is inserted into the insertion opening and thus to transfer the clamping portion into a clamping position in which the electrical wire inserted into the insertion opening is electrically contacted by the contact element of the connection terminal. For this purpose, the release element comprises a release portion which is designed to interact with the electrical wire when inserted into the insertion opening. By interacting with the electrical wire, the release portion is released and therefore the locking engagement between the actuation element and the release element is undone, and the actuation element is thus released from the actuated position.

After undoing the locking engagement, the actuation element can move back, in particular automatically, towards the non-actuated position, preferably under spring preload. The actuation element can be subjected to spring preload in particular by the clamping portion, which is elastically deflected in the actuated position and, after the actuation element has been released, acts upon the actuation element in a resiliently mechanical manner to transfer the actuation element from the actuated position towards the non-actuated position.

Since the release portion of the release element is deflected when the electrical wire is inserted, the connection terminal closes automatically when the electrical wire is inserted. This results in a simple connection process, with reliable contact between the electrical wire and the contact element as a result of the clamping effect of the clamping portion.

In one embodiment, the housing defines a receiving space into which the electrical wire can be introduced by inserting it into the insertion opening. The release portion extends into the receiving space to interact with the electrical wire. In particular, the electrical wire can be inserted into the insertion opening along an insertion direction, wherein the release portion extends transversely to the insertion direction within the receiving space. The release portion can be elastically deflected relative to the supporting portion of the release element so that the release portion is elastically adjusted when interacting with the electrical wire.

While the supporting end is preferably supported in a torque-tight manner relative to the housing, the release portion can be elastically moved in the receiving space and extends in the receiving space in such a way that an electrical wire inserted into the insertion opening strikes the release portion when introduced into the receiving space and thus deflects it.

In one embodiment, the release portion engages, in a locking position, with the actuation element located in the actuated position. The release portion can be moved from the locking position to release the actuation element from the actuated position by interacting with the electrical wire. The actuation element is thus locked in the actuated position via the release portion. By deflecting the release portion from the locking position, the locking engagement can be released such that the actuation element is released from the actuated position, and thus the clamping portion of the spring element can be moved from the release position towards a clamping position.

In one embodiment, the spring element is designed as a tension spring. In this case, the clamping portion of the spring element is designed to pull the electrical wire into abutment with the contact element by spring force. In this case, for example, an opening can be formed in the clamping portion through which the electrical wire can be guided when it is inserted into the insertion opening in the housing in order to pull the electrical wire into clamping contact with the contact element after the clamping portion has been released from the release position.

Alternatively, the spring element can be designed as a compression spring. In this case, the clamping portion is designed to push the electrical wire into abutment with the contact element by spring force. When inserted into the insertion opening, the electrical wire enters a space between the clamping portion and the contact element, wherein, after the clamping portion has been released from the release position, the clamping portion acts upon the electrical wire and pushes it into abutment with the contact element.

In one embodiment, the clamping portion is elastically movable relative to the housing into a release position by actuating the actuation element and is held in the release position relative to the housing by the actuation element locked in the actuated position. The clamping portion is thus locked in the release position relative to the housing such that the clamping portion remains in the release position after the actuation of actuation element.

The spring element can, for example, have a supporting portion, via which the spring element is supported on the housing and held in position on the housing. The clamping portion can be elastically deflected relative to the supporting portion, wherein, in the release position, the clamping portion is deflected such that the spring element is elastically loaded and the clamping portion is moved out of the release position under elastic pretension after being released from the release position.

In one embodiment, the supporting end of the release element is arranged on the supporting portion. The supporting end can in particular be supported on the supporting portion such that torques from the release element on the supporting portion can be absorbed via the support on the supporting portion of the spring element and diverted via the supporting portion. The supporting portion thus fixes the supporting end of the release element in a stationary manner relative to the housing and is preferably held in a torque-resistant manner relative to the housing, wherein the release portion extends from the supporting end and can be elastically deflected towards the supporting end, in particular by interacting with the electrical wire inserted into the insertion opening.

In one embodiment, the release element has an opening through which the supporting portion of the spring element extends. Because the supporting portion engages in the opening of the release element, the release element is, in the region of the supporting end, arranged on the supporting portion and is supported on the supporting portion, preferably in such a way that, when the electrical wire acts upon the release portion, a desired torque is absorbed and supported on the supporting end, and the release portion is thus elastically deflected relative to the supporting end. Due to the elastic deflection, the release portion is automatically returned to its original position when the release portion no longer interacts with the electrical wire, so that, when the actuation element is actuated again, a locking engagement in the actuated position of the actuation element is again established, and the actuation element can therefore be held in the actuated position via the release element.

In one embodiment, the actuation element is mounted on the housing so as to be pivotable about a pivot shaft and has an actuating portion for actuation by a user and an active portion for acting upon the clamping portion. While the actuating portion is accessible from outside the housing, e.g., by a user being able to act upon the actuating portion using a tool, such as a screwdriver, or, alternatively, manually, the active portion is operatively connected to the clamping portion of the spring element. By moving the actuation element, a movement force is thus exerted on the clamping portion via the active portion such that, in particular when the actuation element is moved from the non-actuated position into the actuated position, the clamping portion is entrained and is thus moved in the direction of the release position.

The actuation element can, for example, be pivotably mounted on the housing via a shaft element and can therefore pivot about the pivot shaft relative to the housing. In one embodiment, the spring element extends around the shaft element supporting the actuation element. This means that the spring element engages around the shaft element at an angle preferably greater than 120°, preferably 150°—for example, by means of a bending portion arranged between the supporting portion and the clamping portion. This makes it possible to ensure that the spring element is mounted centrically to the pivot shaft of the actuation element in such a way that the clamping portion can be deflected substantially centrically to the pivot shaft relative to the supporting portion. The pivot point of the actuation element and the pivot point of the clamping portion are therefore at least approximately the same. This means that the clamping portion, by actuating the actuation element, can be easily moved, with advantageous force introduction, without changing the position of the actuation element relative to the clamping portion when pivoting. In addition, the actuation element can be easily reset by the action of the clamping portion when the locking engagement is released.

In one embodiment, the actuation element has a through-opening through which the spring element passes. The spring element can in particular be formed by a bent plate spring, in which the clamping portion can be deflected along a movement plane relative to the supporting portion. The spring element extends through the through-opening in the actuation element, e.g., around the pivot shaft of the actuation element, such that the spring element is supported by means of the supporting portion on the housing on a first side of the actuation element, and the clamping portion protrudes from the actuation element on a remote second side and is moved, together with the actuation element, when the actuation element is moved. This results in an installation space-efficient arrangement of the actuation element and the spring element, with force being effectively introduced into the spring element when the actuation element is transferred from the non-actuated position to the actuated position and also from the spring element into the actuation element when the actuation element is returned from the actuated position as a result of the preload of the spring element.

The actuation element can have two side surfaces extending parallel to one another and spaced apart along the pivot shaft of the actuation element, between which side surfaces the passage opening is formed so that the passage opening is closed on both sides. The spring element extends through the through-opening and protrudes on a first side with the supporting leg from the actuation element and protrudes on a second side with the clamping portion from the actuation element.

In another embodiment, the actuation element can also be open on one side, e.g., by the actuation element having a side surface on one side, but no further side surface spaced apart from said side surface along the pivot shaft. The through-opening is therefore open on one side (viewed along the pivot shaft). This allows, if necessary, a simple installation of the spring element on the actuation element, which can be easily attached to the actuation element.

In one embodiment, the actuation element has a locking portion for engaging with a locking device of the release element when in the actuated position. The locking portion can, for example, be arranged on a side, facing away from the actuating portion, of the actuation element (with respect to the pivot shaft of the pivotable bearing for the actuation element on the housing), preferably approximately diametrically remote from the actuating portion with respect to the pivot shaft. By means of the locking portion, the actuation element is locked in the actuated position by an associated locking device of the release element such that the actuation element is thereabove held in the actuated position, but can be released from the actuated position in a simple and reliable manner by releasing the release portion when the electrical wire is inserted.

The locking device of the release element can be formed, for example, by an opening in which the locking portion of the actuation element, for example formed by a projection, engages when the actuation element is in the actuated position. The actuation element is thus retained in position in its actuated position by the interlocking engagement of the locking portion in the opening of the release element, wherein the engagement can be released by adjusting the release portion, and the actuation element can thus be released from the actuated position to transfer the clamping portion into the release position.

The opening with which the locking portion of the actuation element engages in the actuated position can, for example, be formed in the release portion of the release element. By moving the release portion, the engagement can be released by the release portion being moved relative to the locking portion of the actuation element and thus releasing the locking connection.

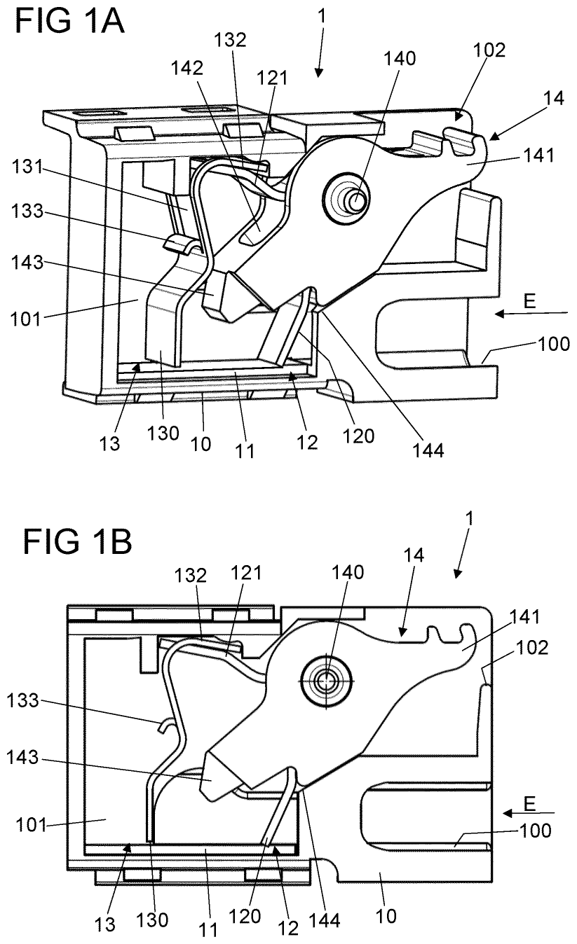

FIG. 1A, 1B to 4A, 4B show an exemplary embodiment of a connection terminal 1 which forms a housing 10 with an insertion opening 100 formed therein for inserting an electrical wire 2 in an insertion direction E.

The housing 10 defines a receiving space 101 into which the electrical wire 2 is introduced by means of a stripped conductor end 20 when it is inserted into the insertion opening 100 in the insertion direction E. In a connected position, the wire 2 with the stripped conductor end 20 is located within the receiving space 101 and is electrically contacted via a clamping portion 120 of a spring element 12 by a contact element 11 in the form of a current bar such that the electrical wire 2 is electrically connected to the connection terminal 1.

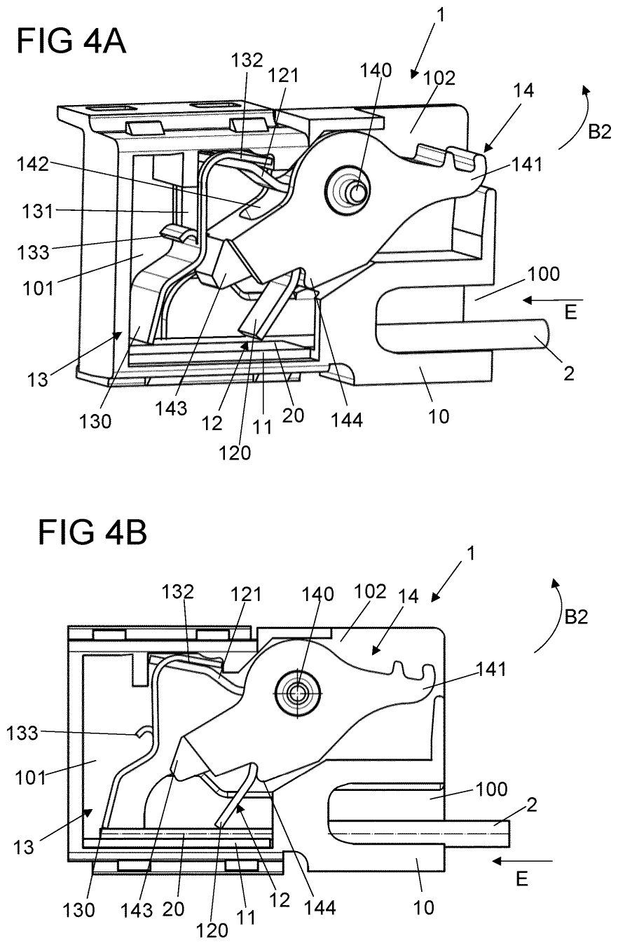

The spring element 12 has a supporting portion 121 which is supported on a wall of the housing 10 such that the spring element 12 is fastened to the housing 10 thereabove and is fixed to the housing 10. The clamping portion 120 can be elastically deflected relative to the supporting portion 121, in particular such that the clamping portion 120 clamps, in a clamping position shown in FIG. 4A, 4B, an electrical wire 2 connected to the connection terminal 1 and pushes this under elastic preload into contact with the contact element 11 and thus brings the wire 2 via its conductor end 20 into electrical contact with the contact element 11.

In the exemplary embodiment shown, an actuation element 14 is pivotably mounted on the housing 10 via a pivot shaft 140. The actuation element 14 can be pivoted about the pivot shaft 140 relative to the housing 10, wherein an actuating portion 141 is accessible from outside the housing 10 via an actuating opening 102 and can thus be actuated by a user—for example, using a tool.

The actuation element 14 is operatively connected to the clamping portion 120 of the spring element 12. For this purpose, the spring element 12 passes through a through-opening 142 within the actuation element 14 such that the spring element 12 engages around the pivot shaft 140. The supporting portion 121 protrudes from the opening 142 on a first side and is supported on the housing 10. The clamping portion 120, on the other hand, protrudes from the actuation element 14 on a remote second side and thus extends within the receiving space 101 in the region of the insertion opening 100 in such a way that the spring element 12 can act via the clamping portion 120 upon an electrical wire 2 inserted into the insertion opening 100 for contacting the contact element 11 and also for mechanical locking.

The connection terminal 1 has a release element 13 which is arranged on the supporting portion 121 of the spring element 12 via a supporting end 132 and is supported a torque-tight manner relative to the housing 10 thereabove. A release portion 130 bent by approximately 90° relative to the supporting end 132 extends from the supporting end 132 and projects into the receiving space 101 substantially transversely to the insertion direction E, and thus extends in a region aligned with the insertion opening 100.

The release portion 130 serves to interact with an electrical wire 2 inserted into the insertion opening 100, in particular to automatically connect the electrical wire 2 to the connection terminal 1 by releasing the clamping portion 120.

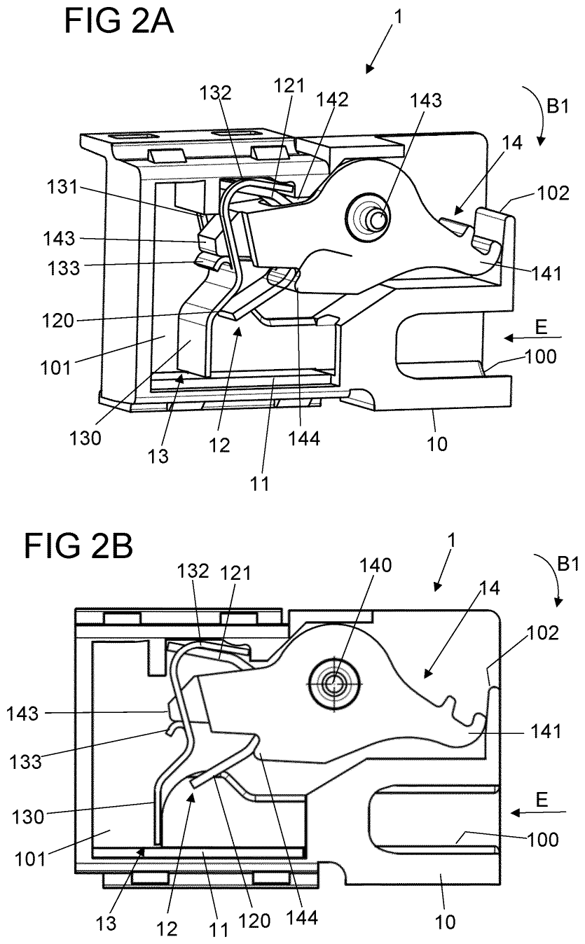

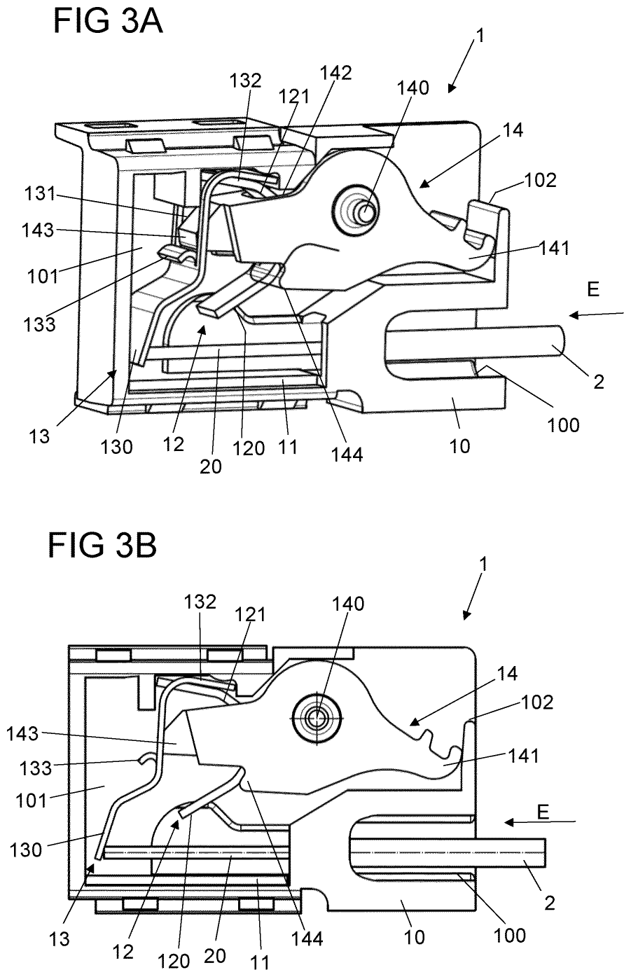

The release element 13 has an opening 131 through which the supporting portion 121 extends to support the supporting end 132 relative to the housing 10, as can be seen, for example, from FIGS. 1A and 1B. In addition, the actuation element 14 is locked in the opening 131 via a locking portion 143 in the form of a projection when the actuation element 14 has been transferred into the actuated position shown in FIG. 2A, 2B in an actuating direction B1. In the actuated position, the actuation element 14 engages in the opening 131 by means of the locking portion 143 and is thereabove held, so as to be locked, on the release portion 130 so that the actuation element 14 is locked in the actuated position according to FIG. 2A, 2B.

If the actuation element 14 is actuated in the actuating direction B1 and thereby pivoted around the pivot shaft 140 relative to the housing 10, the actuation element 14 entrains the clamping portion 120 of the spring element 12 via an active portion 144 and thereby moves the clamping portion 120 into a release position shown in FIG. 2A, 2B. In the release position, the clamping portion 120 releases a region, aligned with the insertion opening 100 in the insertion direction E, within the receiving space 101 such that an electrical wire 2 can be inserted into the insertion opening 100, unhindered by the clamping portion 120, and thus connected to the connection terminal 1 substantially without any force.

If an electrical wire 2 with a stripped conductor end 20 is inserted into the insertion opening 100 and thereby introduced into the receiving space 101 in the insertion direction E while the actuation element 14 is in the actuated position and thus the clamping portion 120 is in the release position, the wire 2 comes into abutment with the release portion 130 of the release element 13 and elastically deflects it relative to the supporting end 132 and thus to the housing 10. As a result, the release portion 130 is moved relative to the locking portion 143 of the actuation element 14 so that the locking portion 143 disengages from the opening 131, and thus the actuation element 14 is released from the actuated position.

On a side, facing the free end of the release portion 130, of the opening 131, a run-on element 133 is formed by a bent portion of the 13 formed as a sheet metal element, onto which release element the locking portion 143 runs when the locking engagement is released. Since the electrical wire 2 also acts with a lever arm upon the release portion 130 which is larger than the lever arm acting upon the locking portion 143, the release portion 130 can be deflected with little force, which is to be applied by the electrical wire 2, and thus the locking engagement can be released easily and reliably when the electrical wire 2 is inserted.

After the locking engagement is released, the actuation element 14 moves out of the actuated position due to the elastic preload on the clamping portion 120 and is returned in an adjustment direction B2 according to FIG. 4A, 4B. The clamping portion 120 comes into clamping abutment with the electrical wire 2 and thereby pushes the conductor end 20 into contacting abutment with the contact element 11 so that the wire 2 is electrically connected to the connection terminal 1 and is also mechanically locked.

Since the actuation element 14 is moved out of the actuated position after the locking engagement is released, a user can safely and reliably detect that the connection terminal 1 has been released and the electrical wire 2 is thus connected to the connection terminal 1. The risk of incorrect operation is thus reduced.

If the electrical wire 2 is to be released from the connected position shown in FIG. 4A, 4B and again removed from the connection terminal 1, the actuation element 14 can be transferred back into the actuated position according to FIG. 2A, 2B so that the clamping portion 120 is not in abutment with the wire 2. The wire 2 can thus be removed from the connection terminal 1 substantially without any force.

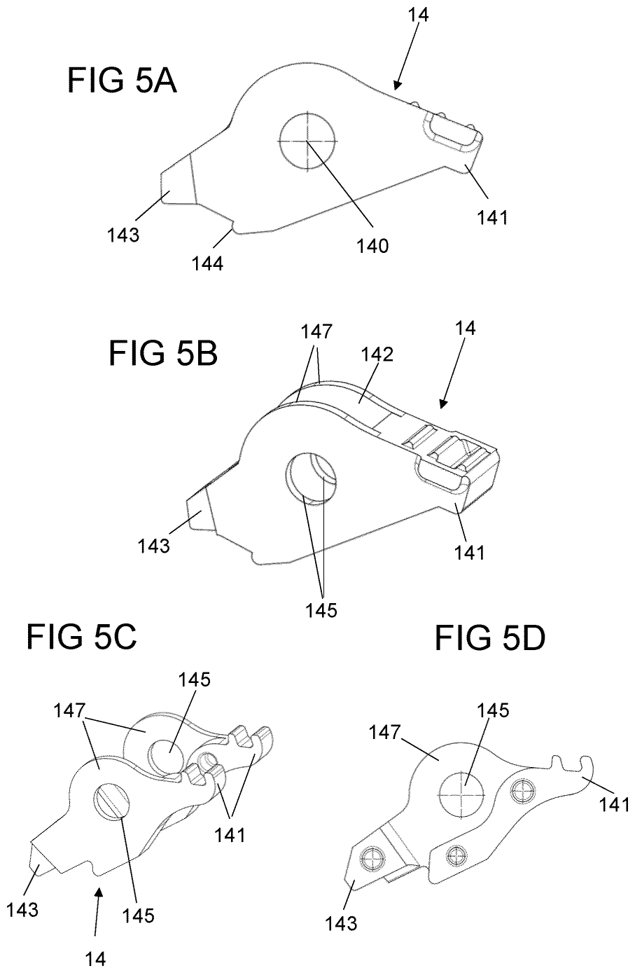

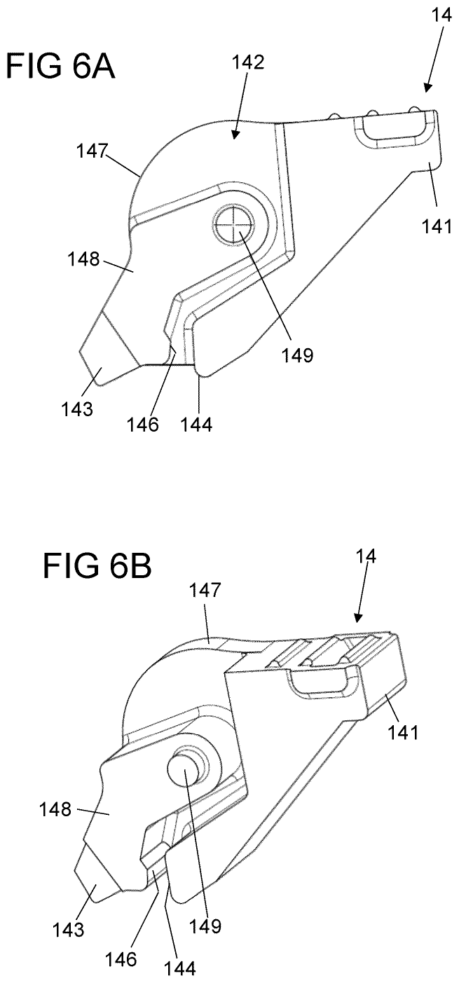

FIG. 5A-5D and FIG. 6A, 6B show two different exemplary embodiments of the actuation element 14, which is mounted on the housing 10 of the connection terminal 1 so as to be pivotable about a pivot shaft 140.

In the exemplary embodiment according to FIG. 5A-5D, the actuation element 14 has a through-opening 142, which is laterally delimited by two side surfaces 147 spaced apart from one another along the pivot shaft 140, and into which the spring element 12 is inserted such that the spring element 12 protrudes from the actuation element 14 on a first side with the supporting portion 121 and on another, second side with the clamping portion 120. The spring element 12 engages around the pivot shaft 140, wherein preferably a pivot point of the clamping portion 120, about which pivot point the clamping portion 120 can be elastically deflected relative to the supporting portion 121, is centric to the pivot shaft 140 of the actuation element 14.

In the exemplary embodiment according to FIG. 5A-5D, a bearing opening 145 is formed on each of the side surfaces 147 of the actuation element 14, through which bearing opening a shaft element formed on the housing 10 extends for supporting the actuation element 14.

In the exemplary embodiment shown, the actuation element 14 is formed by two component halves, as can be seen from FIG. 5C, which shows the two halves separated, and FIG. 5D, which shows a separate half. To form the actuation element 14, the halves are fixedly connected to one another—for example, by means of a screw, rivet, or adhesive connection.

In another embodiment, it is also conceivable to produce the actuation element 14 in one piece as an integral part.

In the exemplary embodiment shown in FIG. 6A, 6B, the actuation element 14 is open on one side in that the actuation element 14 has a side surface 147 but no further side surface spaced along the pivot shaft 140. A through-opening 142 formed in the actuation element 14 is thus open on one side, which can facilitate the insertion of the spring element 12 into the actuation element 14 during installation.

In the exemplary embodiment according to FIG. 6A, 6B, on the side surface 147, a raised portion 148 is formed, which forms a shaft element 149 for supporting the actuation element 14 on the housing 10. The spring element 12 engages with a bending portion 122, formed between the supporting portion 121 and the clamping portion 120, around the shaft element 149 at an angle of approximately 180° and lies with the clamping portion 112 in a slot 146 formed in the raised portion 148. The spring element 12 is therefore supported and guided with the clamping portion 120 on the actuation element 14, wherein a pivot point of the clamping portion 120, about which pivot point the clamping portion 120 is elastically deflected relative to the supporting portion 121 when said clamping portion is moved, is located at least approximately centrically to the pivot shaft 140 of the actuation element 14.

Since the pivot point of the clamping portion 120 is at least approximately centric to the pivot shaft 140 of the actuation element 14, the clamping portion 120 can be easily moved via the actuation element 14 without the clamping portion 120 changing its position relative to the actuation element 14. This results in a favorable introduction of force into the clamping portion 120 when the actuation element 14 is moved into the actuated position and, vice versa, from the clamping portion 120 into the actuation element 140 when returned.

The concept upon which the invention is based is not limited to the embodiment described above, but can also be realized in another way.

The release element can be supported on the spring element via a supporting end, but can also be fixed (directly) to the housing. The release element is preferably supported in a torque-tight manner relative to the housing via the supporting end such that the release portion can be elastically deflected towards the supporting end and can thus automatically return to a relaxed starting position after deflection.

The release element can, for example, be designed as a sheet metal element. However, other designs of the release element are also conceivable and possible—for example, being made of plastic.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Connection terminal
10 Housing
100 Insertion opening
101 Receiving space
102 Engagement opening
11 Contact element (current bar)
12 Clamping spring
120 Clamping portion
121 Supporting portion
122 Bending portion
13 Release element
130 Release portion
131 Locking device (locking opening)
132 Supporting end
133 Run-on element
14 Actuation element
140 Pivot shaft
141 Actuating portion
142 Through-opening
143 Locking portion
144 Active portion
145 Bearing opening
146 Slot
147 Side surfaces
148 Raised portion
149 Shaft element
2 Wire
20 Conductor end
B1 Actuation direction
B2 Return direction
E Insertion direction

1. A connection terminal for connecting an electrical wire, comprising:
a housing having an insertion opening into which the electrical wire is insertable for connection to the connection terminal;
a contact element arranged on the housing, the contact element being configured to electrically contact the electrical wire;
a spring element arranged on the housing, the spring element having a clamping portion configured to interact with the electrical wire to bring the electrical wire into contact with the contact element;
an actuation element, pivotally arranged on the housing, the actuation element being movable from a non-actuated position into an actuated position so as to move the clamping portion; and
a release element having a supporting end arranged to be stationary relative to the housing and a release portion elastically movable relative to the supporting end,
wherein the actuation element is configured to engage the release element when in the actuated position so as to hold the actuation element in the actuated position,
wherein the release portion is configured to interact with the electrical wire when the electrical wire is inserted into the insertion opening so as to release the actuation element from the actuated position.

2. The connection terminal of claim 1, wherein that the housing defines a receiving space into which the electrical wire is introducible by being inserted into the insertion opening, and
wherein the release portion extends in the receiving space so as to interact with the electrical wire.

3. The connection terminal of claim 2, wherein the electrical wire is insertable into the insertion opening in an insertion direction, and
wherein the release portion extends transversely to the insertion direction within the receiving space.

4. The connection terminal of claim 1, wherein, in a locking position, the release portion is configured to engage the actuation element located in the actuated position and is movable from the locking position by interacting with the electrical wire so as to release the actuation element from the actuated position.

5. The connection terminal of claim 1, wherein the clamping portion is configured to push or pull the electrical wire into abutment with the contact element by spring force.

6. The connection terminal of claim 1, wherein the clamping portion is elastically movable relative to the housing into a release position by actuating the actuation element and is held in the release position relative to the housing by the actuation element locked in the actuated position.

7. The connection terminal of claim 1, wherein the spring element has a supporting portion which is supported on the housing and relative to which the clamping portion is elastically deflectable.

8. The connection terminal of claim 7, wherein the supporting end is arranged on the supporting portion.

9. The connection terminal of claim 7, wherein the release element has an opening through which the supporting portion extends.

10. The connection terminal of claim 1, wherein the actuation element is mounted on the housing so as to be pivotable around a pivot shaft, and
wherein the actuation element has an actuating portion for actuation by a user and an active portion configured to act upon the clamping portion.

11. The connection terminal of claim 10, wherein the spring element extends around a shaft element supporting the actuation element.

12. The connection terminal of claim 1, wherein the actuation element has a through-opening through which the spring element passes.

13. The connection terminal of claim 1, wherein the actuation element has a locking portion configured to engage a locking device of the release element when in the actuated position.

14. The connection terminal of claim 13, wherein the locking device includes an opening of the release element, in which opening the locking portion is configured to engage when the actuation element is in the actuated position.

15. The connection terminal of claim 14, wherein the locking portion is releasable from the opening by deflecting the release portion by interacting with the electrical wire inserted into the insertion opening.
